(19) United States
(12) Patent Application Publication
(10) Pub. No.: US 2026/0072574 A1
(43) Pub. Date: Mar. 12, 2026

(54) Dashboard Interface For Initiating Actions Determined As A Function Of A Message

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/928,572

(22) Filed: Oct. 28, 2024

Related U.S. Application Data
(60) Provisional application No. 63/691,479, filed on Sep. 6, 2024.

(51) Int. Cl. G06F 3/0484; H04L 51/21

(52) U.S. Cl. CPC G06F 3/0484; H04L 51/21

(57) ABSTRACT

Techniques for generating and executing candidate actions from a message include detecting a message and determining a particular set of message attributes corresponding to the message.

One or more target states are computed based on the particular set of message attributes, and a set of one or more candidate actions are determined for actions that are configured to produce the one or more target states. The candidate actions are concurrently displayed with the message in a messaging interface of a dashboard, where the dashboard is a component of a GUI presented by an application. Responsive to receiving a selection of a first candidate action of the set of candidate actions, the system initiates execution of the first candidate action by the application.

### BENEFIT CLAIMS; RELATED APPLICATIONS; INCORPORATION BY REFERENCE

This application claims the benefit of U.S. Provisional Patent Application 63/691,479, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to a dashboard interface for an application that initiates actions in the application from messages received by the dashboard interface. In particular, the present disclosure relates to an application that reviews messages received in a messaging interface, determines candidate actions based on the messages, and initiates execution of a candidate action by the application.

### BACKGROUND

Some applications provide a messaging interface that allows users to communicate requests and information. The information in messages may indicate that further action is needed on the part of the recipient. To act based on the message information, the user needs to read the message, interpret the language to determine what actions may be needed, and then perform the action or instruct the application to perform the action.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. One should note that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for determining candidate actions based on a message in a dashboard interface in accordance with one or more embodiments;

FIG. 3 illustrates an example of a dashboard interface in accordance with one or more embodiments;

FIG. 4. illustrates another example of a dashboard interface in accordance with one or more embodiments;

FIG. 5 illustrates an example of a machine learning process in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. APPLICATION TRIGGERING ARCHITECTURE
3. DETERMINING CANDIDATE ACTIONS FROM MESSAGES
4. EXAMPLE EMBODIMENTS
5. MACHINE LEARNING
6. PRACTICAL APPLICATIONS, ADVANTAGES, AND IMPROVEMENTS
7. COMPUTER NETWORKS AND CLOUD NETWORKS
8. HARDWARE OVERVIEW
9. MISCELLANEOUS; EXTENSIONS

### 1. General Overview

One or more embodiments analyze messages addressed to a user to determine, present, and initiate application actions that are external to a messaging component that is used to present the messages to the user. The system monitors messages that are being presented to a user in a messaging interface. The system applies a Natural Language Processing (NLP) model to the message to determine a particular set of message attributes corresponding to the message. Based on the message attributes, the system determines a target state for a component or application that is external to the messaging interface. The system then determines a set of one or more candidate actions that can be initiated by the particular user. The candidate actions in the set of candidate actions are configured to produce the one or more target states. The system concurrently displays the message in the messaging interface and the set of candidate actions. The message and the set of candidate actions may be presented within a same component or different components of a graphical user interface (GUI) presented by an application. The system receives a selection of a first candidate action of the set of candidate actions and initiates execution of the first candidate action in response to receiving the selection of the first candidate action.

In an example, the system presents a medical data dashboard for a doctor. The system receives a message for the doctor that includes lab results for a patient. Based on the message and historical action data associated with prior messages, the system determines a target state that includes a prescription order being placed for the patient. The system further determines that this target state may be achieved via the placement of the prescription order by the doctor. The system concurrently displays both (a) the message with the lab results and (b) various interface elements to order various prescription medications for the patient. Upon receiving the selection of an interface element that corresponds to ordering a particular prescription medication, the system places the order for the particular prescription medication on behalf of the doctor.

One or more embodiments described in this Specification and/or recited in the claims may not be included in this General Overview section.

### 2. Application Triggering Architecture

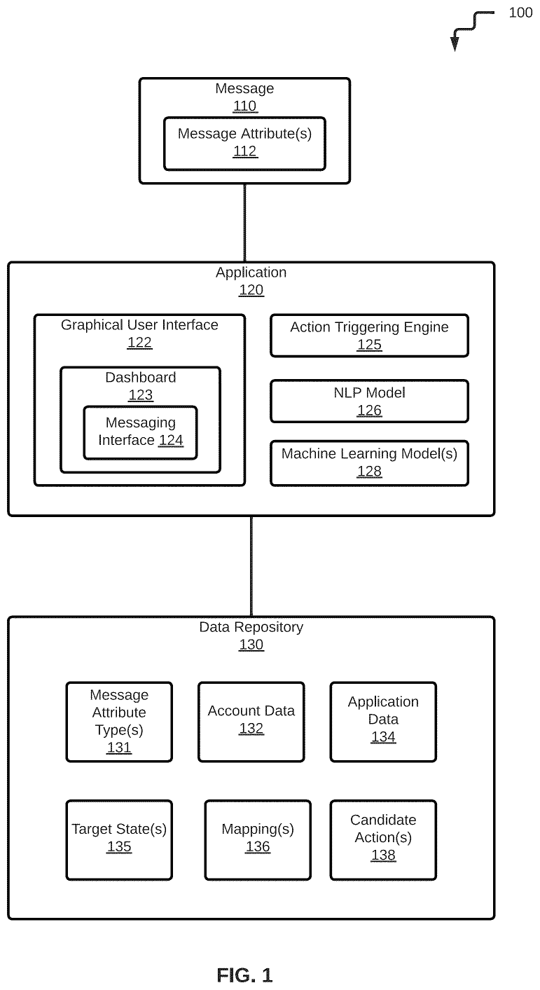

FIG. 1 illustrates a system 100 in accordance with one or more embodiments. As illustrated in FIG. 1, system 100 includes an application 120 and a data repository 130. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

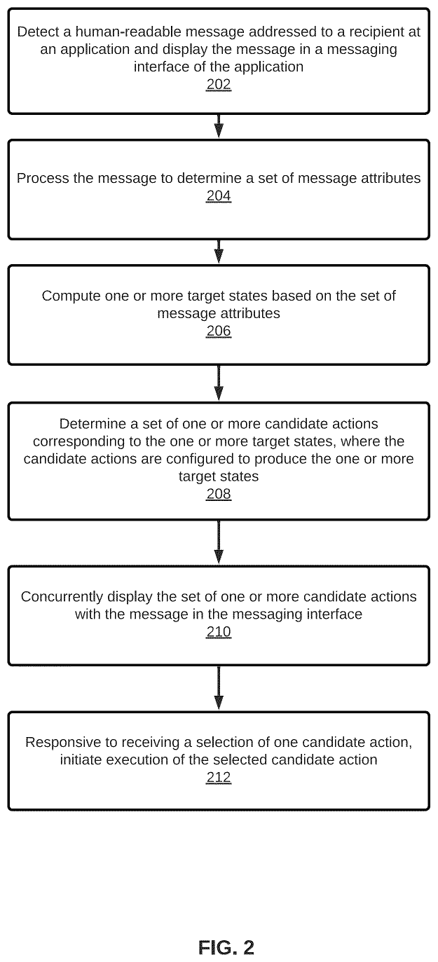

In one or more embodiments, the application 120 refers to hardware and/or software configured to perform operations described herein for identifying target states based on received messages and determining one or more candidate actions that, when executed, can result in the target state. The application 120 may be a business management application, such as a medical practice application, with a dashboard with an interactive messaging interface that allows users to interact with other users and with clients, store and retrieve information and data records, and initiate actions. The application 120 may include one or more functional components, such as a graphical user interface (GUI) 122, an action triggering engine 125, a natural language processing (NLP) model 126, and a machine learning model 128. Examples of operations for determining candidate actions based on a message in a dashboard interface are described below with reference to FIG. 2.

The application 120 may be configured to receive a message 110 from a user of the application or from an external user, such as a client or a patient. The message 110 may be in a human-readable format, for example, text entered from a keyboard, or from a speech-to-text conversion operation. The message may be an email message, a text message, or a chat message. The message may be machine generated or from a human user. The message 110 may have one or more message attributes 112 of one or more message attribute types 131. Message attribute types 131 may include, for example, a keyword, a timestamp, a sender identity, and/or a recipient identity. A keyword may include a word or word phrase that is mapped to information and/or an action that the application can execute. A timestamp may identify a date and time when the message was sent, received, read, and/or stored. A sender identity may include a name, an address, and/or a unique identifier for an individual or entity that sent the message. A recipient identity may include a name, an address, and/or a unique identifier for an individual or entity to whom the message is directed.

The application 120 may generate and display a variety of GUI components with GUI 122 to allow users to interact with the functions and information of the application. The GUI 122 refers to hardware and/or software configured to facilitate communications between a user and the application 120. GUI 122 renders user interface elements and receives input via user interface elements. Examples of user interface elements include checkboxes, radio buttons, dropdown lists, list boxes, buttons, toggles, text fields, date and time selectors, command lines, sliders, pages, and forms.

In an embodiment, different components of GUI 122 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, GUI 122 is specified in one or more other languages, such as Java, C, or C++. GUI 122 displays the message 110 in a messaging interface 124 within the dashboard 123. The messaging interface 124 may include, for example, a message display component and a message composition field.

The GUI 122 can include a dashboard 123. The dashboard 123 includes the messaging interface 124. The dashboard 123 may also include other interface components that present information from the application 120 and allow a user to interact with the operations of the application 120.

The action triggering engine 125 can identify the message attributes of the message, for example, by using the NLP model 126 to identify keywords, other words, and word phrases in the message. The action triggering engine 125 may also determine timestamp information as well as sender information, intended recipient information, and other message attributes.

The action triggering engine 125 may be configured to access application information based on the message attributes to determine one or more target states and identify one or more candidate actions for the application to execute based on the message and message attributes. Target states 135 represent a state of the application when an application function is completed. A target state may not be specific to a sender or recipient of a message. Examples of target states can include the following: an appointment is scheduled; a supply is ordered; an invoice is sent; a bill is paid; and a test is ordered. The action triggering engine 125 determines a target state from the message attributes, for example, using a machine learning model 128.

Application information can include account data 132. Account data 132 may include information identifying and describing clients served by the application. The information can include contact information, account numbers, data records about the user or client, and so forth. For a medical practice application, the account data can include patient records that include current and past medical conditions, medications, test results, and so forth. For a commercial business practice application, the account data can include client accounts, billing and invoice records, work product produced for a client, contracts, and so forth.

Application information can include application data 134. Application data 134 can include information used by the application 120 as part of the functions the application performs. For example, the application data 134 can include calendar and scheduling information, personnel accounts, and application-specific reference information. For a medical practice application, the application data 134 can include information about medications, conditions addressed by the medications, available dosages for the medications, contraindications for the medications, and so forth. The application data 134 could include, for the users of the applications, employee records, specialties, certifications, hospital privileges, and so forth.

The action triggering engine 125 can create and use mappings 136 to determine target states from a message. A mapping 136 can be an association between a message attribute and a target state. For example, a particular keyword or keyword phrase can be mapped to a target state.

During a mapping process, a target state may be mapped to a message attribute when a target state is achieved subsequent to receiving a message having the message attribute within a threshold period of time after the message is received. For example, the system can compare a timestamp for when the message is received to the timestamp associated with creating a data set that produces the target state. When the difference between the two timestamps is within a threshold amount, the system maps the message attribute to the target state. The data set that produces the target state may be, for example, a calendar entry, an order of an item, a receipt, and so forth.

A message attribute indicating a test result and/or a diagnosis may be mapped to a target state of “medication ordered.” A message attribute indicating a new complaint or symptom may be mapped to a target state of “appointment scheduled.” A message attribute indicating a meeting request may be mapped to a target state of “appointment scheduled.” A message attribute indicating that a report is needed may be mapped to a target state of “data collection initiated.”

In an embodiment, the action triggering engine 125 may be configured to access other applications external to the application 120 and external to a messaging interface. In an embodiment, a target state can be associated an application that is external to and different from the application 120 and/or a messaging application that was used to transmit or receive the message. For example, a target state can be “database updated” where the application 120 updates an external database associated with a database application. A target state can be “financial transaction completed” where the application 120 instructs a banking application or a payroll application to make a transaction.

In another example, an automated reminder message received from a vehicle service department for routine service may be mapped to a target state of “service completed”. The action triggering engine 125 can access the recipient's calendar and generate candidate actions for scheduling service at the service department. In another example, an office printer may generate and send a message indicating that the ink or toner supply is low. The action triggering engine 125 may determine a target state of “ink ordered”. The action triggering engine 125 may search online vendors for inventory and generate candidate actions for placing an order for the indicated supply item with options for lowest cost, fastest shipping, and/or other parameters.

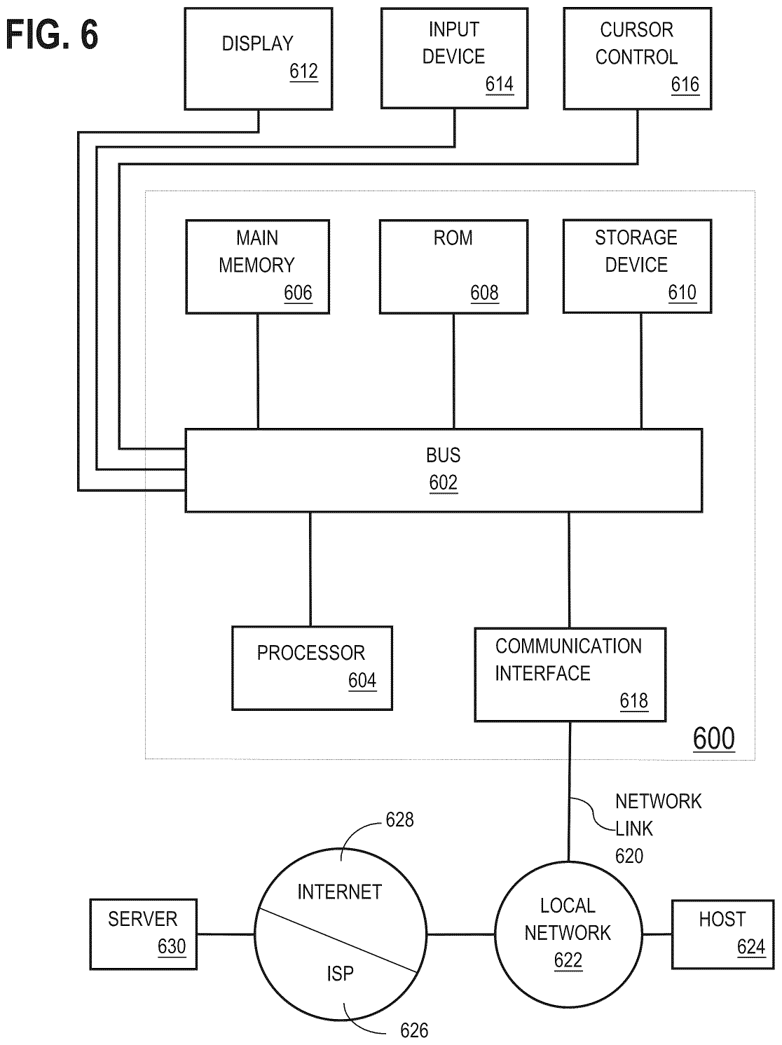

The action triggering engine 125 can generate candidate actions 138 based on the target states and the message attributes of a message. A candidate action 138 can be a function or operation that the application 120 can execute. A candidate action 138 can be a function or operation that an external application can execute. When generated, the candidate action is in an unexecuted state. For example, a candidate action can be for generating or editing a calendar entry, ordering a supply item, ordering a prescription, ordering a test, generating a referral order, generating and/or sending an invoice, or sending a reminder message. The action triggering engine 125 can use a machine learning model 128 to determine a set of candidate actions based on the target states. There may be individual machine learning models 128 for respective target states or one machine learning model that takes a target state as an input to generate candidate actions. The dashboard 123 presents an interface element corresponding to a candidate action in the messaging interface 124. An example of a machine learning model and process is described below with reference to FIG. 6.

In one or more embodiments, a data repository 130 is any type of storage unit and/or device (e.g., a file system, database, collection of tables, or any other storage mechanism) for storing data. Furthermore, a data repository 130 may include multiple different storage units and/or devices. The multiple different storage units and/or devices may or may not be of the same type or located at the same physical site. Furthermore, a data repository 130 may be implemented or executed on the same computing system as application 120. Additionally, or alternatively, a data repository 130 may be implemented or executed on a computing system separate from application 120. The data repository 130 may be communicatively coupled to application 120 via a direct connection or via a network.

Additional embodiments and/or examples relating to computer networks are described below in Section 7 titled “Computer Networks and Cloud Networks.”

Information describing message attribute types 131, account data 132, application data 134, target states 135, mappings 136, and candidate actions 138 may be implemented across any of components within the system 100. However, this information is illustrated within the data repository 130 for purposes of clarity and explanation.

### 3. Determining Candidate Actions from Messages

FIG. 2 illustrates an example set of operations for determining candidate actions based on a message in a dashboard interface in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system detects a human-readable message addressed to a recipient at an application and displays the message in a messaging interface of the application (Operation 202). The message may be part of a human-to-human communication that includes full or partial sentences, abbreviations, and colloquialisms that may or may not conform to grammatical and spelling rules of the language. The system detects the message, for example, at a messaging inbox or when a user enters text into a message composition field of the messaging interface, for example, from a keyboard, a speech-to-text conversion operation, or a drag-and-drop operation using text selected from elsewhere. The message may be received as an email message, a text message, e.g., an SMS message, or as a chat message. The message may include information identifying an intended recipient, such as an email address, a telephone number, a username, or a chat handle.

In an embodiment, the system processes the message to determine a set of message attributes (Operation 204). The system may parse the message to identify keywords, for example, with an NLP model. The system may also identify one or more message attributes from metadata or other data associated with the message, such as the sender of the message, an addressed recipient, a timestamp for when the message was sent, and a timestamp for when the message was received and/or viewed.

In an embodiment, the system computes one or more target states based on the set of message attributes (Operation 206). The system may refer to mappings of message attributes to target states to compute a target state. For example, if a message includes words such as “meet”, “schedule”, “time to discuss”, and so forth, a target state may be “appointment scheduled”. If a message includes words such as “refill”, “order more,” “need more”, or the like in association with a noun, a target state may be “<noun> ordered”. In another example, if the message includes words that are symptoms of a medical condition or words that indicate a problem with a system, a target state may be “test ordered”. If a message does not include words that directly correlate to a target state, the system may still compute one or more target states. For example, if a message includes a diagnosis or a test result, the system may identify one or more medications used to treat the diagnosed condition or address the test result and compute a target state of “<medication> ordered.”

In an embodiment, a target state does not include any specific details about how the target state is to be achieved, for example, a specific time for an appointment or a specific quantity of an item to order. A target state may include or refer to one or more message attributes. For example, the system may use message attributes identifying the addressed recipient and the sender to compute a target state of “appointment scheduled between <identified sender> and <identified recipient>”. In another example, the system may use a message attribute identifying the sender to compute a target state of “<noun> ordered for <identified sender>.”

In an embodiment, the system determines a set of one or more candidate actions based on the one or more target states (Operation 208). For a given target state, the system may identify what information is needed to create a corresponding candidate action. For example, for a scheduling-related target state, the system may identify the individual who will participate in the appointment. The system may use keywords and/or other message attributes to select a duration for the appointment. The system may then access the individual's calendar and look for one or more available time slots of the determined duration. The system creates a draft calendar event for an available time slot as a candidate action.

In another example, for a medication refill ordered target state, the system may identify the sender of the message as the individual to whom the medication is prescribed, i.e., the patient, and the medications previously prescribed to the patient. The system may also identify the prescriber of the medication. The system creates a respective draft prescription refill order as a candidate action for one or more of the patient's prescriptions. The system may determine the number of refills remaining on the patient's prescriptions and create draft prescription refill orders for just the prescriptions with no refills remaining.

In another example, for a lab test ordered target state, the system may identify a test to order based on words and other message attributes in the message that relate to a symptom or problem. The system creates a draft lab test order as a candidate action.

The system may use a machine learning model to determine the set of candidate actions. The machine learning model may be specific to a target state and take message attributes as inputs and may output the set of candidate actions. The machine learning model may take a target state, message attributes, or both as inputs and may output the set of candidate actions.

In an embodiment, the system concurrently displays the set of candidate actions with the message in the messaging interface (Operation 210). The system creates a separate interface element for the respective candidate action in the set of candidate actions. The system presents the interface elements in the messaging interface, for example, below the received message or to the side of the received message.

In an embodiment, the system receives a selection of a candidate action and initiates execution of the selected candidate action (Operation 212). The system may identify a selection operation from the user, for example, a mouse button click, when an associated cursor is positioned over an interface element. The system may instruct the application to perform the selected candidate action, for example, by issuing a command or function call corresponding to the candidate action.

### 4. Example Embodiments

Several detailed examples are described below for purposes of clarity. Components and/or operations described below should be understood as one specific example that may not be applicable to certain embodiments. Accordingly, components and/or operations described below should not be construed as limiting the scope of any of the claims.

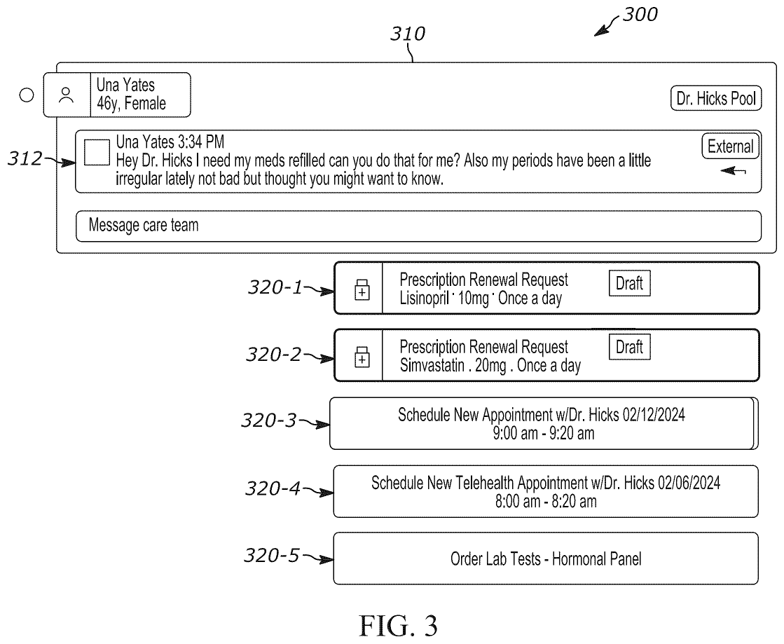

FIG. 3 illustrates an example of a dashboard interface 300 in accordance with one or more embodiments. The illustrated dashboard interface 300 is a component of a medical practice application and includes a messaging interface 310. The messaging interface 310 displays a message 312. In the illustrated example, message 312 was received from a patient “Una Yates”. Message 312 may have been received as a text message or an email message directed to the medical practice in general or to a particular member of the medical staff. Accordingly, the message attributes include the sender's identity, “Una Yates”; an addressed recipient “Dr. Hicks”; a receipt timestamp, “3:34 PM”; an indication that the message came from outside of the medical practice; and the body of the message.

The system identifies words and/or keywords in the body of the message, e.g., “meds” and “refilled”, along with symptom words “periods” and “irregular”. The system computes a target state of “prescription refilled” based on the words “meds” and “refilled”. The system computes a target state of “appointment scheduled with Dr. Hicks” based on identifying symptom words. The system also computes a target state of “lab test ordered” based on the symptom words.

For the “prescription refilled” target state, the system identifies the medications prescribed to the message sender and generates respective candidate actions to refill the medications prescribed to the sender. The system displays interface elements 320-1 and 320-2 for the respective candidate actions.

For the “appointment scheduled with Dr. Hicks” target state, the system accesses the calendar information for Dr. Hicks. The system may also use the symptom words to determine a length of appointment to reserve, for example, based on historical data, or using a trained machine learning model. The system identifies two possible appointment slots in Dr. Hicks' calendar and creates a candidate action for an in-person appointment and a candidate action for a telehealth appointment. The system displays interface elements 320-3 and 320-4 for the respective candidate actions.

For the “lab test ordered” target state, the system uses the symptom words to identify a particular lab test that is used in response to the symptom words based on historical data or using a trained machine learning model. The system creates a draft lab test order for the particular lab test as a candidate action and displays the interface element 320-5 for the candidate action. The user, e.g., Dr. Hicks or a member of the medical staff, can select one or more of the interface elements 320 to initiate execution of the candidate action.

In an embodiment, the system may determine if the user viewing the message is capable of, or authorized to, initiate execution of a candidate action. For example, if a non-medical staff person is viewing the message, the system may disable interface elements, e.g., elements 320-1 and 320-2, for candidate actions that require a doctor or nurse practitioner to execute the action. The system may send the message and/or the candidate actions that the current viewing user cannot execute to another user who can execute the candidate actions.

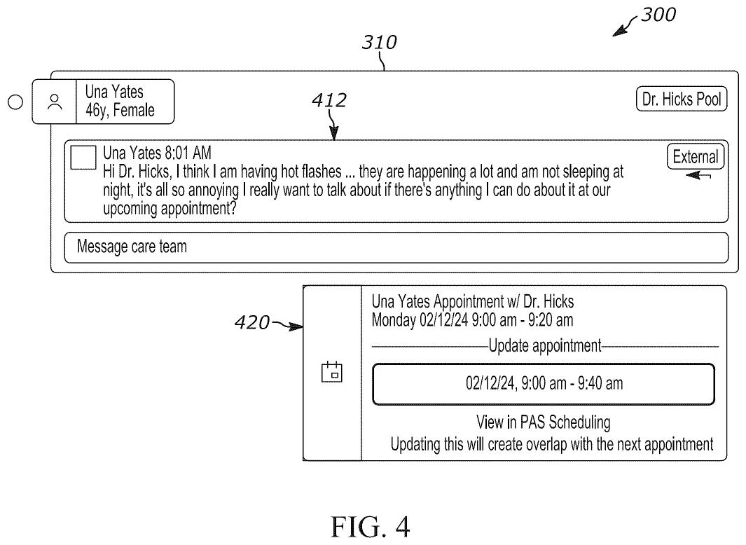

FIG. 4 illustrates another example of a candidate action the system can generate and present in the dashboard 300. In the illustrated example, the message sender already has an appointment scheduled with the message recipient. The system determines message attributes from the message 412, including symptom words, such as “hot flashes”, “happening a lot”, “not sleeping”, and the phrase “want to talk about it”. The system computes a target state of “appointment scheduled”. The system identifies that an appointment already exists for the message sender and the addressed recipient and computes a new target state of “existing appointment extended”. The system accesses the calendar for the addressed recipient, “Dr. Hicks”, and identifies an available time slot that can accommodate the amount of time allotted to the original appointment plus additional time. The system may use the symptom words to determine how much additional time to add to the original amount of time based on historical data or using a trained machine learning model. The system generates a candidate action to update the original appointment to the new timeslot and displays an interface element 420 for the candidate action.

### 5. Machine Learning

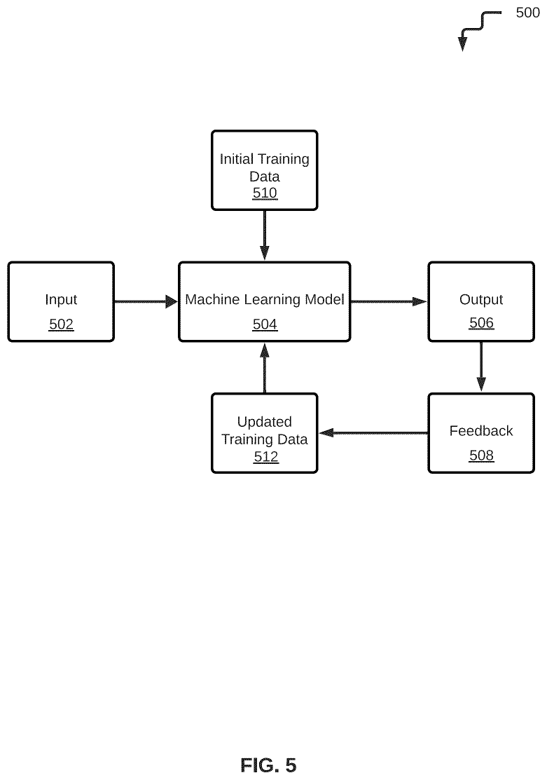

FIG. 5 illustrates a machine learning process 500 according to one or more embodiments. A machine learning model 504 may be iteratively trained on initial training data 510 to map a set of input variables to an output variable. The initial training data 510 for a machine learning model trained to compute target states may include message attributes and target states mapped to one or more message attributes. The initial training data 510 for a machine learning model trained to generate candidate actions may include target states and candidate actions mapped to target states.

Once trained initially, the machine learning model 504 may act on an input 502. A machine learning model trained to compute target states may act on input that includes message attributes to produce output 506 in the form of one or more target states. A machine learning model trained to compute candidate actions may act on input that includes target states to produce output 506 in the form of one or more candidate actions.

The training data may be updated based on, for example, feedback 508 on the accuracy of the current machine learning model 504. Updated training data 512 is fed back into the machine learning algorithm that, in turn, updates the machine learning model 504.

A machine learning model 504 is trained so that the model best fits the datasets of training data to the labels or outputs of the training data. Additionally, or alternatively, machine learning model 504 is trained so that when the model is applied to the datasets of the training data, a maximum number of results determined by the model matches the labels or outputs of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 6. Practical Applications, Advantages, and Improvements

Some messaging and communication interfaces generate potential responses to a message as shortcuts for the user. These potential responses, however, are limited to the messaging interface and generally do not affect or direct the operation of the messaging or communication interface, other than to prompt a response from a chatbot within the messaging or communication interface. In some cases, the messaging or communication interface may provide a link to a website for more information or where the user can take further action, but without making it possible for the user to cause an application to complete an action.

One or more embodiments analyze messages addressed to a user to determine, present, and initiate application actions that are external to a messaging component that is used to present the messages to the user. The user can initiate an application action from within the messaging interface without having to navigate away from the messaging interface and without having to fill in parameters use by the action manually.

The system processes messages to identify actions that an application can perform to address problems, issues, and requests included or implied by a message. The system can create the candidate actions concurrently. The user of the application can then simply select one or more of the possible actions to instruct the application to execute the action. In this way, the user does not have to perform time-consuming steps to execute the action, such as looking up another person's calendar for a schedule opening or looking up medications to order and generating the refill order. If multiple actions are indicated by a message, a human user would generally need to generate the actions serially, adding to the time needed to achieve the target states.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 6 is a block diagram that illustrates a computer system 600 that can be used to implement an embodiment of the disclosure. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic that, in combination with the computer system, causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into the remote computer's dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606. Processor 604 retrieves and executes the instructions from main memory 606. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. Example forms of transmission media include the signals through the various networks, the signals on network link 620, and the signals that carry the digital data to and from computer system 600 through communication interface 618.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as the code is received, and/or stored in storage device 610, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form that such claims issue, including any subsequent correction.

What is claimed is:

1. One or more non-transitory computer readable media comprising instructions that, when executed by one or more hardware processors, cause performance of operations comprising:
detecting a message, addressed to a particular user, in a human-readable format;
applying a Natural Language Processing (NLP) model to the message to determine a particular set of message attributes corresponding to the message;
computing one or more target states based on the particular set of message attributes corresponding to the message;
determining a set of one or more candidate actions that can be initiated by the particular user, wherein the candidate actions in the set of candidate actions are configured to produce the one or more target states;
concurrently displaying the message and the set of candidate actions in a messaging interface, the messaging interface being a component of a Graphical User Interface (GUI) presented by a first application;
receiving a selection of a first candidate action of the set of candidate actions; and
initiating execution of the first candidate action in response to receiving the selection of the first candidate action.

2. The one or more non-transitory computer readable media of claim 1, wherein the operations further comprise:
determining a second set of candidate action that can be initiated by a second user, wherein the candidate actions in the second set of candidate actions are configured to produce the one or more target states; and
sending the message to the second user.

3. The one or more non-transitory computer readable media of claim 1, wherein the operations further comprise:
generating a mapping between message attributes and target states, wherein the one or more target states are computed based further on the mapping.

4. The one or more non-transitory computer readable media of claim 1, wherein the operations further comprise:
generating a mapping that maps a first target state to a first message attribute in response to determining that the first target state was achieved subsequent to and within a threshold period of time after receiving a message with the first message attribute,
wherein the one or more target states comprise the first target state, wherein the particular set of message attributes comprise the first target state, and wherein the one or more target states are computed based further on the mapping.

5. The one or more non-transitory computer readable media of claim 4, wherein determining the first target state was achieved subsequent to and within a threshold period of time after receiving the message comprises:
determining a first timestamp associated with receipt of the message;
determining a second timestamp associated with creation of a data set comprised in the first target state; and
determining that the second timestamp is subsequent to and within a threshold period of time from the first timestamp.

6. The one or more non-transitory computer readable media of claim 1, wherein the operations further comprise:
training a machine learning model to compute target states based on message attributes based on training data sets, wherein the training data sets include a first training data set comprising:
a first message attribute; and
a first target state mapped to the first message attribute;
wherein computing the one or more target states based on the particular set of message attributes comprises applying the machine learning model to the particular set of message attributes to determine the one or more target states.

7. The one or more non-transitory computer readable media of claim 1, wherein the operations further comprise:
training a machine learning model to determine candidate actions based on target states based on training data sets, wherein the training data sets include a first training data set comprising:
a first target state; and
a first candidate action mapped to the first target state;
wherein computing the one or more candidate actions based on the one or more target states comprises applying the machine learning model to the one or more target states to determine the one or more candidate actions.

8. The one or more non-transitory computer readable media of claim 1, wherein the operations further comprise:
receiving, by a first instance of the first application, a request to forward a second selected candidate action for execution and/or approval to a different recipient; and
presenting, by a second instance of the first application, the second selected candidate action for execution and/or approval by a different recipient.

9. The one or more non-transitory computer readable media of claim 1, wherein the set of candidate actions include an action for placing a first prescription order for a first medication and an action for placing a second prescription order for a second medication, wherein the first and second medications are determined based on the message attributes.

10. The one or more non-transitory computer readable media of claim 1, wherein the set of candidate actions include an action for placing a first prescription order for a first dosage of a particular medication and an action for placing a second prescription order for a second dosage of the particular medication.

11. The one or more non-transitory computer readable media of claim 1, wherein the one or more target states are associated at least with one application that is external to and different from a messaging application that was used to transmit or receive the message.

12. A method comprising:
detecting a message, addressed to a particular user, in a human-readable format;
applying a Natural Language Processing (NLP) model to the message to determine a particular set of message attributes corresponding to the message;
computing one or more target states based on the particular set of message attributes corresponding to the message;
determining a set of one or more candidate actions that can be initiated by the particular user, wherein the candidate actions in the set of candidate actions are configured to produce the one or more target states;
concurrently displaying the message and the set of candidate actions in a messaging interface, the messaging interface being a component of a Graphical User Interface (GUI) presented by a first application;
receiving a selection of a first candidate action of the set of candidate actions; and
initiating execution of the first candidate action in response to receiving the selection of the first candidate action;
wherein the method is performed by at least one device including a hardware processor.

13. The method of claim 12, further comprising:
determining a second set of candidate actions that can be initiated by a second user, wherein the candidate actions in the second set of candidate actions are configured to produce the one or more target states; and
sending the message and the second set of candidate actions to the second user.

14. The method of claim 12, wherein computing the one or more target states comprises:
identifying an issue or a problem based on the set of message attributes; and
determining that the one or more target states will resolve the issue or problem.

15. The method of claim 12, further comprising:
generating a mapping between message attributes and target states, wherein the one or more target states are computed based further on the mapping.

16. The method of claim 12, further comprising:
generating a mapping that maps a first target state to a first message attribute in response to determining that the first target state was created subsequent to and within a threshold period of time after receiving a message with the first message attribute,
wherein the one or more target states comprise the first target state, wherein the particular set of message attributes comprise the first target state, and wherein the one or more target states are computed based further on the mapping.

17. The method of claim 16, wherein determining the first target state was created subsequent to and within a threshold period of time after receiving the message comprises:
determining a first timestamp associated with receipt of the message;
determining a second timestamp associated with creation of a data set comprised in the first target state; and
determining that the second timestamp is subsequent to and within a threshold period of time from the first timestamp.

18. The method of claim 12, further comprising:
training a machine learning model to compute target states based on message attributes based on training data sets, wherein the training data sets include a first training data set comprising:
a first message attribute; and
a first target state mapped to the first message attribute;
wherein computing the one or more target states based on the particular set of message attributes comprises applying the machine learning model to the particular set of message attributes to determine the one or more target states.

19. The method of claim 12, further comprising:
receiving, by a first instance of the first application, a request to forward a second selected candidate action for execution and/or approval to a different recipient; and
presenting, by a second instance of the first application, the second selected candidate action for execution and/or approval by a different recipient.

20. A system comprising:
at least one device including a hardware processor;
the system being configured to perform operations comprising:
detecting a message, addressed to a particular user, in a human-readable format;
applying a Natural Language Processing (NLP) model to the message to determine a particular set of message attributes corresponding to the message;
computing one or more target states based on the particular set of message attributes corresponding to the message;
determining a set of one or more candidate actions that can be initiated by the particular user, wherein the candidate actions in the set of candidate actions are configured to produce the one or more target states;
concurrently displaying the message and the set of candidate actions in a messaging interface, the messaging interface being a component of a Graphical User Interface (GUI) presented by a first application;
receiving a selection of a first candidate action of the set of candidate actions; and
initiating execution of the first candidate action in response to receiving the selection of the first candidate action.
